(19) United States
(12) Patent Application Publication
(10) Pub. No.: US 2021/0113870 A1
(43) Pub. Date: Apr. 22, 2021

(54) AERIAL JET ENGINE FIRE EXTINGUISHING METHODOLOGY

(71) Applicant: MARK R. ZIEGENFUSS, RINGOES, NJ (US)

(72) Inventor: Mark R. ZIEGENFUSS, Ringoes, NJ (US)

(21) Appl. No.: 16/602,505

(22) Filed: Oct. 21, 2019

(51) Int. Cl. A62C 3/02; A62C 5/00

(52) U.S. Cl. CPC A62C 3/0228; A62C 5/004; A62C 3/0207

(57) ABSTRACT

An aerial jet engine fire extinguishing methodology includes: identifying an undesired fire; providing an airplane with at least one jet engine with an exhaust that may be directed toward the fire; flying the airplane in the proximity of the fire with the exhaust directed toward the fire, the flying being at an altitude sufficient to deliver carbon dioxide and other exhaust gases from the exhaust to the fire to at least partially deprive the fire of oxygen and to thereby snuff out at least a portion of the fire. The airplane may be manned or an unmanned drone.

### REFERENCE TO RELATED APPLICATIONS

The present application is not related to any pending or issued United States of America or foreign patent or patent application.

### BACKGROUND OF INVENTION

### a. Field of Invention

The present invention generally relates to extinguishing forest fires and other significant undesired fires, such as catastrophic combustible material fires (oil well fires, gas storage tank fires, chemical plant fires, etc.). The invention is an aerial jet engine fire extinguishing methodology that involves providing an airplane with at least one jet engine with an exhaust that may be directed toward an undesired fire and flying the airplane in the proximity of the fire with the exhaust directed toward the fire at an altitude sufficient to deliver carbon dioxide and other exhaust gases from the exhaust to the fire to at least partially deprive the fire of oxygen and to thereby snuff out at least a portion of the fire. Preferably, there may be two or more such jet engines for snuffing out the fire, and they may be dedicated (separate from the main propulsion engines of the plane), or may be the actual main propulsion engines of the plane. In some cases, the plane may be a VTOL plane (vertical take off and landing) that can rotate and direct the engines, and in others, dedicated engine(s) may be fixed or rotatable.

### b. Description of Related Art

The following are prior art patents are representative of the field pertaining to the present invention:

U.S. Pat. No. 8,460,570 B2 to Elliot describes foams and methods of using foams for fighting fires in confined areas (i.e., mine shafts) are provided. In one embodiment, a foam for extinguishing a fire is provided. The foam includes a surfactant; a non-flammable liquid; and an inert gas having a density substantially less than air. Preferably, the density of the foam is substantially less than the density of air. The light foam will allow a basic form of directional control of the foam because the light foam will float towards the ceiling of a cavern or mine shaft. This offers fire fighters several options in extinguishing an underground fire. In column 2 of this reference, it is noted that other cave fire extinguishing techniques include carbon dioxide injection. It further states that in one instance a jet engine was used to suppress a cave fire by injecting an entire mine with carbon dioxide.

U.S. Pat. No. 8,291,990 B1 to Mohr describes a firefighting system for fighting forest and brush fires under dry, hot and windy conditions which includes a jet engine for generating a high speed air stream, a water source for supplying water to a cooling system which lowers the water temperature to between forty and fifty degrees Fahrenheit, a nozzle for injecting cold water into the air steam and a filter which provides very fine particles of cold water within the stream. The stream of cold water is directed to a forest or brush fire dropping the temperature of the fire which eventually extinguishes the fire. In one instance (column 4, referring to its FIG. 6, the reference describes the use of a group of jet engines used to generate high velocity air steams to carry water to a fire. This is different from the present invention as it is ground-positioned, and uses water injection.

Notwithstanding the prior art, the present invention is neither taught nor rendered obvious thereby.

### SUMMARY OF INVENTION

The present invention is an aerial jet engine fire extinguishing methodology, which includes the following steps: identifying an undesired fire; providing an airplane with at least one jet engine with an exhaust that may be directed toward the fire; flying the airplane in the proximity of the fire with the exhaust directed toward the fire, the flying being at an altitude sufficient to deliver carbon dioxide and other exhaust gases from the exhaust to the fire to at least partially deprive the fire of oxygen and to thereby snuff out at least a portion of the fire.

In some embodiments of the present invention aerial jet engine fire extinguishing methodology, the airplane has at least two jet engines with exhausts that may be directed toward the fire and the methodology includes flying the airplane in the proximity of the fire with the two exhausts directed toward the fire, the flying being at an altitude sufficient to deliver carbon dioxide and other exhaust gases from the two exhaust to the fire to at least partially deprive the fire of oxygen and to thereby snuff out at least a portion of the fire.

In some embodiments of the present invention aerial jet engine fire extinguishing methodology, the airplane is a jet airplane and the at least one jet engine with an exhaust that may be directed toward the fire is selected from the group consisting of: at least one primary propulsion jet engine; at least one jet engine that is separate from a primary propulsion jet engine; and combinations thereof. In some of these embodiments of the present invention aerial jet engine fire extinguishing methodology, the jet airplane is a VTOL jet airplane.

In some embodiments of the present invention aerial jet engine fire extinguishing methodology, the flying is over the undesired fire, while in others, the flying is adjacent the undesired fire.

In some embodiments of the present invention aerial jet engine fire extinguishing methodology, the airplane has at least one fixed jet engine with an exhaust that may be directed toward the fire and is directed toward the fire by plane flight angle adjustments. In other embodiments, the airplane has at least one rotatable jet engine with an exhaust that may be directed toward the fire and is directed toward the fire by angle adjustments by rotation of the at least one rotatable jet engine.

In some embodiments of the present invention aerial jet engine fire extinguishing methodology, the at least one rotatable jet engine with an exhaust that may be directed toward the fire further includes a second, opposing jet engine to counter thrust of the at least one rotatable jet engine with an exhaust that may be directed toward the fire. In some of these embodiments, the methodology includes a second airplane, being a shadow airplane with an exhaust deflector, that closely follows the airplane and is positioned to and does deflect exhaust from the second, opposing jet engine so as to direct it towards the fire.

In some different embodiments of the present invention aerial jet engine fire extinguishing methodology, the aerial jet engine fire extinguishing methodology, includes: identifying an undesired fire; providing an unmanned, remotely operated drone airplane with at least one jet engine with an exhaust that may be directed toward the fire; flying the airplane in the proximity of the fire with the exhaust directed toward the fire, the flying being at an altitude sufficient to deliver carbon dioxide and other exhaust gases from the exhaust to the fire to at least partially deprive the fire of oxygen and to thereby snuff out at least a portion of the fire. It should be further noted that all of the preceding paragraphs in this Summary are intended to be manned flights and that all of the manned flight variations, specifics and details described above apply as well to the unmanned drone airplane.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE SEVERAL VIEWS OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a block diagram of the salient features of the present invention method;

FIG. 2 shows a side view of a present invention method in operation, illustrating a plane with normal commercial or military main jet engines wherein the plane is flown at a tilt, nose up, using the main jet engine exhaust to fight a fire;

FIG. 3 shows a side view of a present invention method in operation, illustrating a plane with commercial or military main jet engines wherein those engines tilt, using the main jet engine exhaust to fight a fire;

FIG. 4 shows a side view of a present invention method in operation, illustrating a plane with commercial or military main jet engines and a concave out and down hydraulic deflector, for the plane to fly above and next to a fire while extinguishing it;

FIG. 5 shows a side view of a present invention method in operation, illustrating a plane with commercial or military main jet engines and a hydraulic, adjustable downward deflector wherein the plane may be a drone that flies over or serpentines a fire to be extinguished;

FIG. 6 shows a side view of a present invention method in operation, illustrating a plane with three commercial or military main jet engines (one on each wing and one on the tail) and a separate, dedicated fire extinguishing jet engine that is rotatable in two dimensions or alternatively rotatable in three dimensions;

FIG. 7 shows a side view of a present invention method in operation, illustrating a plane with commercial or military main jet engines and one or more separate, dedicated fire extinguishing dual connected jet engines that have side intakes and opposing thrusts for extinguishing fires;

FIG. 8 shows a side view of a present invention method in operation, illustrating a plane with commercial or military main jet engines and one or more separate, dedicated fire extinguishing dual connected jet engines that have side intakes and opposing thrusts for extinguishing fires, and a second, higher flying plane deflecting the up-thrust of the first plane to apply more exhaust to a fire.

### DETAILED DESCRIPTION OF THE EMBODIMENTS

The present invention relates to methods of extinguishing a fire with an aerial jet engine, i.e., while the jet plane is flying.

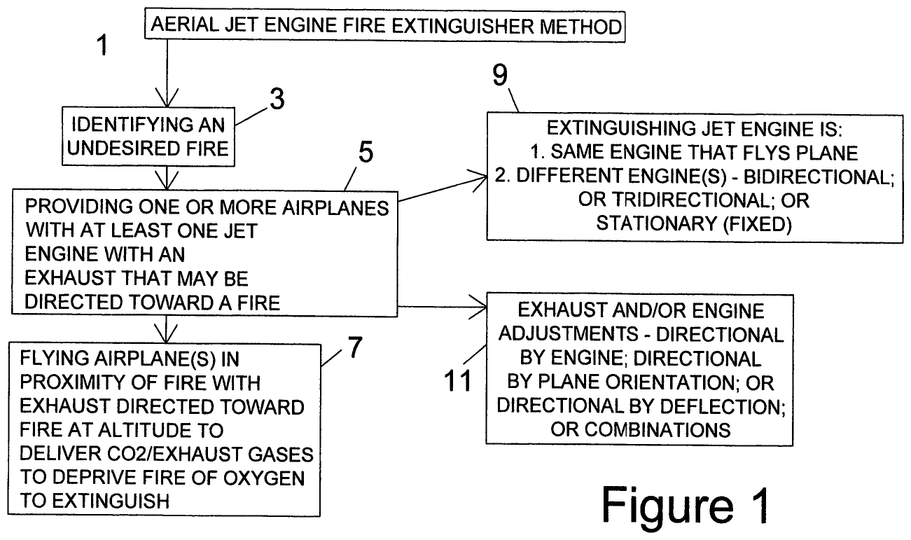

FIG. 1 shows a block diagram of the salient features of the present invention method of extinguishing a fire with an aerial jet engine, block 1. By aerial jet engine is meant a jet engine that is in the air, as opposed to a jet engine mounted on the ground or on a vehicle on the ground. The first step in the present invention method is to identify a fire, block 3, in need of being extinguished. Next, block 5, providing one or more airplanes with at least one jet engine (and typically two jet engines) having an exhaust that may be directed toward the fire. And, next, block 7, flying the airplane(s) near the fire while directing the jet engine(s) exhaust toward the fire. This flying is done at an effective altitude, e.g., at an altitude of a few hundred feet or less, to deliver carbon dioxide and other exhaust gases to the fire, thereby depriving the fire of oxygen and at least partially extinguishing it. Block 9 establishes that the extinguishing jet engine(s) may be the same engine(s) that fly the plane or other engines that are dedicated to extinguishing the fire. These different engines may be bi-directional, (so as to rotate about a single axis, such as a horizontal axis for rotational swiveling), or tri-directional (as on double axes, for rotation on a first axis and the tilting on a second axis). This enables the pilot or drone operator to tilt the engine down, as well as out and away from the plane, such as for flying aside the fire rather than directly above it. Block 11 shows that the engine orientation toward a fire may be achieved in these methods by directing the jet engine (swivel); by directing the plane (as, for example, tilting the plane to direct exhausts to the fire, while using flaps and elevators to stabilize the plane flight, either in a straight path, a vertical serpentine path, a horizontal serpentine path, or a combination thereof.

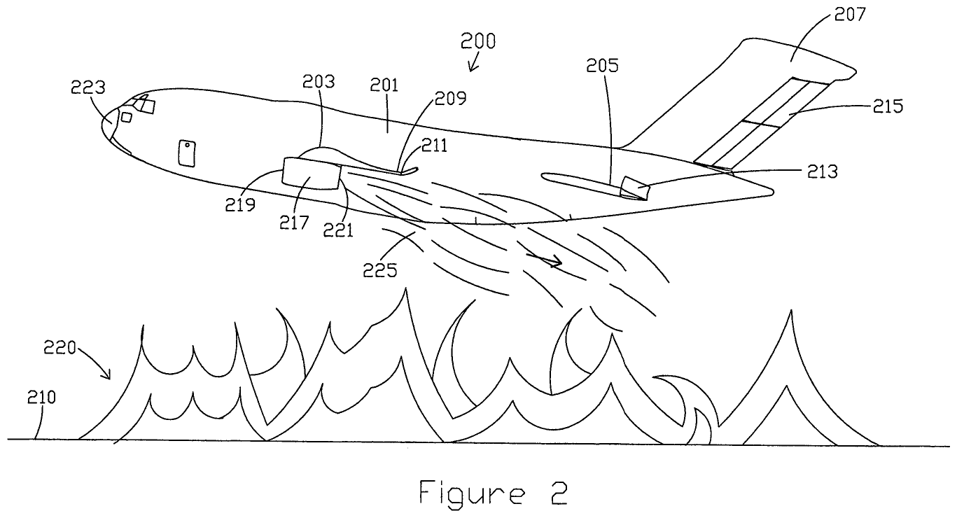

FIG. 2 shows a side view of a present invention method in operation, illustrating a plane 200 with a fuselage 201, nose 223, forward wing 203, rear (horizontal) stabilizer wing 205, a rear (vertical) stabilizer tailfin 207 with rudder 215. Forward wing 203 has flaps 209 and aileron 211, and normal commercial or military main jet engines, such as engine 217 with intake port 219 and exhaust port 221 wherein the plane is flown at a tilt, as shown, using the main jet engine exhaust 225 to fight a fire 220 at ground or object 210. The proper adjustment of the flaps, aileron and elevators will enable the pilot to tilt and maintain a nose up position and altitude within functional ranges to at least partially extinguish the fire. Note that many of the parts of plane 200 are illustrated below and are not re-described.

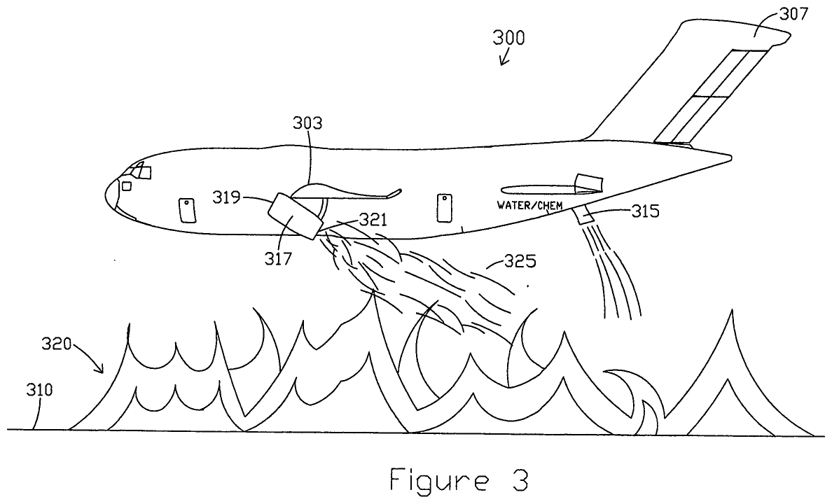

FIG. 3 shows a side view of a present invention method in operation, illustrating a plane 300, having many of the same features as plane 200 above, with fuselage 301, forward wing 303, tail 307, etc., except with commercial or military main jet engines such as engine 317 with intake port 319 and exhaust port 321, wherein the engines tilt, by hydraulic lever 311, and then the main jet engine exhaust 325 is utilized to fight fire 320 at forest 310. This plane is also equipped with a water or water/chemical storage tank, not shown, with controlled fire spraying outlet 315 to further assist with extinguishment.

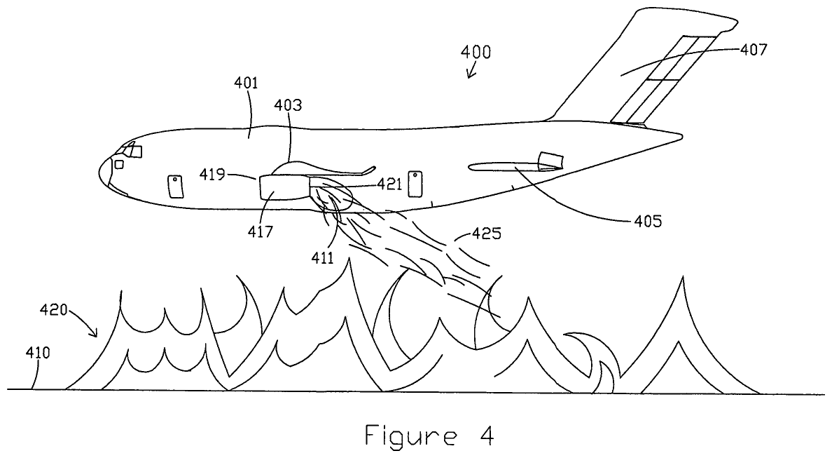

FIG. 4 shows a side view of a present invention method in operation, illustrating a jet plane 400, with a fuselage 401, forward wing 403, tail wing 405, tail 407, etc. with commercial or military main jet engines 417 with intake port 419, exhaust port 421. Adjacent the exhaust port 421 is a concave out and down hydraulic deflector 411, for the plane to fly above and next to a fire 420, directing exhaust gases 425 to extinguish fire 420 on rooftop 410. There is a mirror image deflector on the opposite side (not shown).

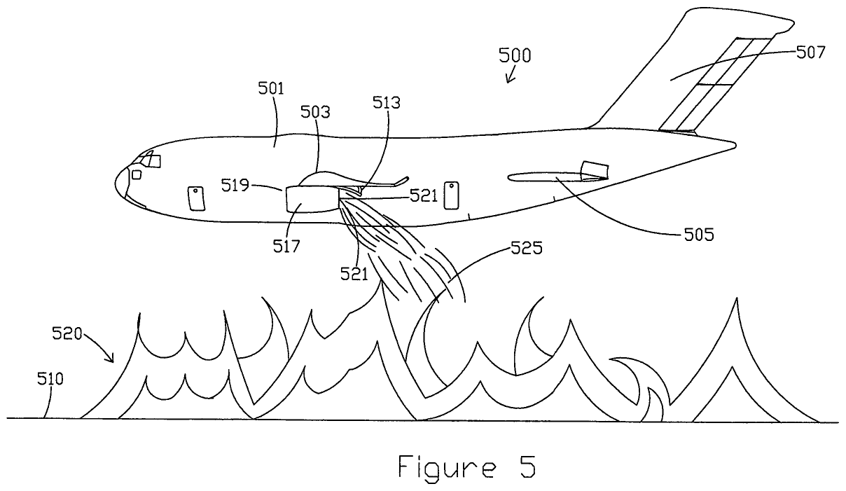

FIG. 5 shows a side view of a present invention method in operation, illustrating a jet plane 500, with a fuselage 501, forward wing 503, tail wing 505, tail 507, etc. with commercial or military main jet engine 517 with intake port 519, exhaust port 521. Adjacent the exhaust port 421 is an under-wing deflector 511 (and a second one on the opposite side, not shown), for the plane to fly above a fire 520, directing exhaust gases 525 to extinguish fire 520 in forest 510. Upward thrust of plane 500 caused by the deflection of exhaust gases may be countered by flap and elevator adjustments. In some instances, these present invention methods involve remote flying from away from the fire, i.e., drone aircraft. Thus, as used anywhere herein, the terms “plane” and “jet plane” may be any jet aircraft that is manned or unmanned.

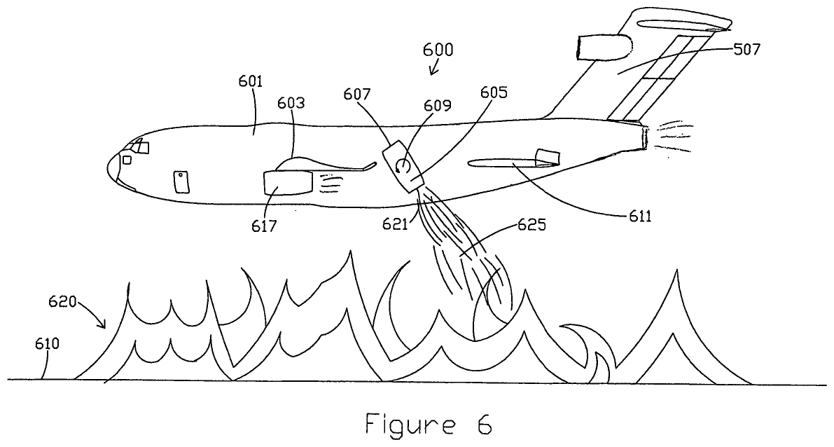

FIG. 6 shows a side view of a present invention method in operation, illustrating a jet plane 600, with a fuselage 601, forward wing 603, tail wing 611, tail 507, etc. with commercial or military main jet engine 617 with intake port 519, exhaust port 521. The left wing is shown with its conventional main jet engine 617, with a symmetrically positioned second such jet engine on the right wing (not shown). There is a third engine, which is a conventional tail engine. on tail 507. Midway down the fuselage is an auxiliary engine 605 dedicated to fire extinguishing efforts with an identical one on the opposite side (not shown). Engine 605 may be rotated by an operator about pivot point 609 to aim it as desired when taking into account the fire being attacked and the plane's resulting upward and forward thrust. Engine 605 has an intake 607 and an exhaust 621. As shown, the exhaust gases 625 are directed downwardly at an angle to extinguish fire 620 on the ground 610. Upward thrust of plane 600 caused by the exhaust gases 625 may be countered by flap and elevator adjustments and there is additional stabilization from the tail wing engine as well. In some instances, these present invention methods involve remote-controlled unmanned flying to/over/near the fire, i.e., with drone aircraft.

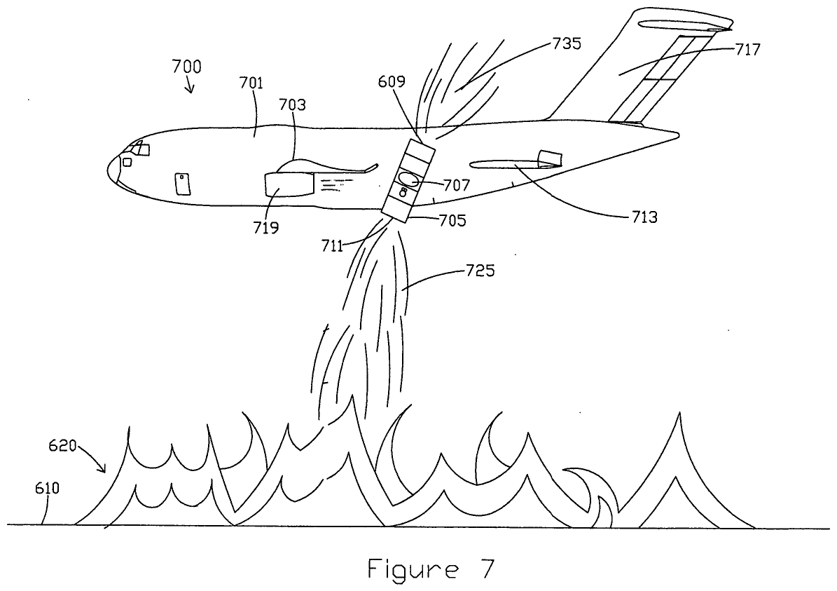

FIG. 7 shows a side view of a present invention method in operation, illustrating a jet plane 700, with fuselage 701, forward wing 703, rear wing 713, tailfin 707, commercial or military main jet engines , such as engine, 719 on forward wing 703 and one or more separate, dedicated fire extinguishing jet engines, such as bidirectionally rotating, bidirectionally firing jet dual engine 705 that has side intake 707 and opposing thrusts 709 and 711 for extinguishing fires. This may be built on the basis of connecting two engines with a side intake, such as shown. The upwardly facing thrust 709 is equal and opposite downward thrust counter each other to minimize thrust effects on plane 700. Downward thrust exhaust 725 extinguishes fire 720 of forest 710, and upward thrust exhaust 735 dissipates into the atmosphere. In another version, the same type of dual, opposing thrusters have a second plane following, with a downward deflector.

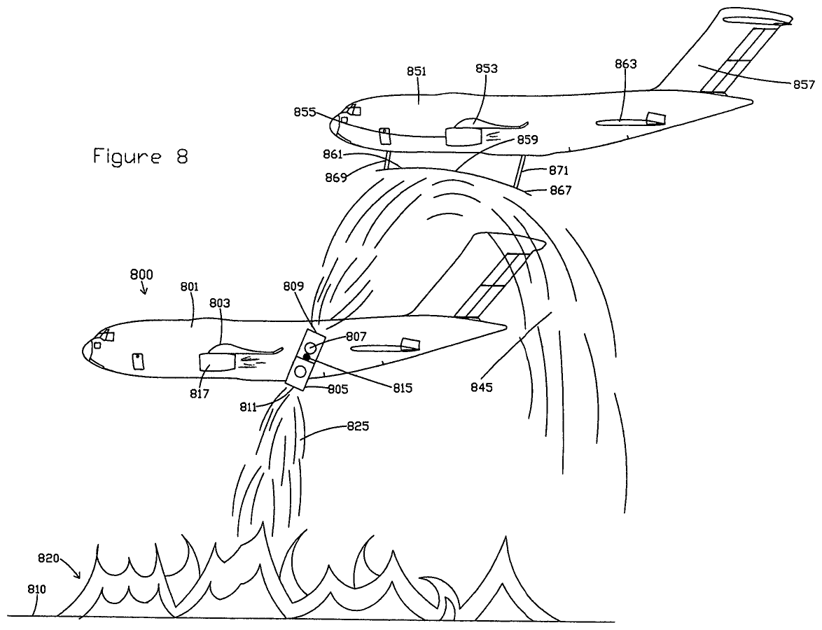

FIG. 8 shows a side view of a present invention method in operation, illustrating a first plane 800 and a shadowing second plane 850, each with commercial or military main jet engines. Plane 800 has main engines, such as engine 817 on forward wing 803, fuselage 801, tail wing 863 and tailfin 857 and other standard jet plane components. Plane 800 also has one or more separate, dedicated fire extinguishing bidirectional dual engines such as is described in FIG. 7 above. Here fire extinguishing rotating, dual jet engines, such as engines 805, has pivot point 815, intakes 807 and 813 and equal and opposite exhaust ports 809 and 811. Both exhaust 825 and 845 are used for extinguishing fires, exhaust 825 by its direct downward flow to fire 820 at forest 810 and upward exhaust 845 by downward deflection from deflector 867 of shadowing plane 850, a second, higher flying plane deflecting the up-thrust of the first plane to apply more exhaust to a fire. Plane 850 has fuselage 851 with powering jet engine 855 on the forward wing. The underside of the fuselage 851 has a three-section deflector 859 that is retracted for take off and landing and extended by hydraulic arms. Ann 869 extends and retracts section 861 and arm 871 extends and retracts section 8767. These deflector components direct upward exhaust 845 back toward fire 820 to aid in extinguishing the fire.

Although particular embodiments of the invention have been described in detail herein with reference to the accompanying drawings, it is to be understood that the invention is not limited to those particular embodiments, and that various changes and modifications may be included therein by one skilled in the art without departing from the scope or spirit of the invention as defined in the appended claims. For example, the actual shape or type of aircraft is not limited by the drawings and could include, e.g., helicopters as well.

What is claimed is:

1. An aerial jet engine fire extinguishing methodology, which comprises:
a) identifying an undesired fire;
b) providing an airplane with at least one jet engine with an exhaust that may be directed toward the fire;
c) flying the airplane in the proximity of the fire with the exhaust directed toward the fire, the flying being at an altitude sufficient to deliver carbon dioxide and other exhaust gases from the exhaust to the fire to at least partially deprive the fire of oxygen and to thereby snuff out at least a portion of the fire.

1. The aerial jet engine fire extinguishing methodology of claim 1 wherein the airplane has at least two jet engines with exhausts that may be directed toward the fire and the methodology includes flying the airplane in the proximity of the fire with the two exhausts directed toward the fire, the flying being at an altitude sufficient to deliver carbon dioxide and other exhaust gases from the two exhaust to the fire to at least partially deprive the fire of oxygen and to thereby snuff out at least a portion of the fire.

2. The aerial jet engine fire extinguishing methodology of claim 1 wherein the airplane is a jet airplane and the at least one jet engine with an exhaust that may be directed toward the fire is selected from the group consisting of: at least one primary propulsion jet engine; at least one jet engine that is separate from a primary propulsion jet engine; and combinations thereof.

3. The aerial jet engine fire extinguishing methodology of claim 3 wherein the jet airplane is a VTOL jet airplane.

4. The aerial jet engine fire extinguishing methodology of claim 1 wherein the flying is over the undesired fire.

5. The aerial jet engine fire extinguishing methodology of claim 1 wherein the flying is adjacent the undesired fire.

6. The aerial jet engine fire extinguishing methodology of claim 1 wherein the airplane has at least one fixed jet engine with an exhaust that may be directed toward the fire and is directed toward the fire by plane flight angle adjustments.

7. The aerial jet engine fire extinguishing methodology of claim 1 wherein the airplane has at least one rotatable jet engine with an exhaust that may be directed toward the fire and is directed toward the fire by angle adjustments by rotation of the at least one rotatable jet engine.

8. The aerial jet engine fire extinguishing methodology of claim 1 wherein the at least one rotatable jet engine with an exhaust that may be directed toward the fire further includes a second, opposing jet engine to counter thrust of the at least one rotatable jet engine with an exhaust that may be directed toward the fire.

9. The aerial jet engine fire extinguishing methodology of claim 9 wherein the methodology includes a second airplane, being a shadow airplane with an exhaust deflector, that closely follows the airplane and is positioned to and does deflect exhaust from the second, opposing jet engine so as to direct it towards the fire.

10. An aerial jet engine fire extinguishing methodology, which comprises:
a) identifying an undesired fire;
b) providing an unmanned, remotely operated drone airplane with at least one jet engine with an exhaust that may be directed toward the fire;
c) flying the airplane in the proximity of the fire with the exhaust directed toward the fire, the flying being at an altitude sufficient to deliver carbon dioxide and other exhaust gases from the exhaust to the fire to at least partially deprive the fire of oxygen and to thereby snuff out at least a portion of the fire.

11. The aerial jet engine fire extinguishing methodology of claim 11 wherein the airplane has at least two jet engines with exhausts that may be directed toward the fire and the methodology includes flying the airplane in the proximity of the fire with the two exhausts directed toward the fire, the flying being at an altitude sufficient to deliver carbon dioxide and other exhaust gases from the two exhaust to the fire to at least partially deprive the fire of oxygen and to thereby snuff out at least a portion of the fire.

12. The aerial jet engine fire extinguishing methodology of claim 11 wherein the airplane is a jet airplane and the at least one jet engine with an exhaust that may be directed toward the fire is selected from the group consisting of: at least one primary propulsion jet engine; at least one jet engine that is separate from a primary propulsion jet engine; and combinations thereof.

13. The aerial jet engine fire extinguishing methodology of claim 13 wherein the jet airplane is a VTOL jet airplane.

14. The aerial jet engine fire extinguishing methodology of claim 11 wherein the flying is over the undesired fire.

15. The aerial jet engine fire extinguishing methodology of claim 11 wherein the flying is adjacent the undesired fire.

16. The aerial jet engine fire extinguishing methodology of claim 11 wherein the airplane has at least one fixed jet engine with an exhaust that may be directed toward the fire and is directed toward the fire by plane flight angle adjustments.

17. The aerial jet engine fire extinguishing methodology of claim 11 wherein the airplane has at least one rotatable jet engine with an exhaust that may be directed toward the fire and is directed toward the fire by angle adjustments by rotation of the at least one rotatable jet engine.

18. The aerial jet engine fire extinguishing methodology of claim 11 wherein the at least one rotatable jet engine with an exhaust that may be directed toward the fire further includes a second, opposing jet engine to counter thrust of the at least one rotatable jet engine with an exhaust that may be directed toward the fire.

19. The aerial jet engine fire extinguishing methodology of claim 19 wherein the methodology includes a second airplane, being a shadow airplane with an exhaust deflector, that closely follows the airplane and is positioned to and does deflect exhaust from the second, opposing jet engine so as to direct it towards the fire.
